(19) United States
(12) Patent Application Publication
(10) Pub. No.: US 2014/0208201 A1
(43) Pub. Date: Jul. 24, 2014

(54) Image Obfuscation in Web Content

(71) Applicant: INTERNATIONAL BUSINESS MACHINES CORPORATION, Armonk, NY (US)

(72) Inventors: Leugim A. Bustelo, Austin, TX (US); Bradley Childs, Austin, TX (US)

(73) Assignee: International Business Machines Corporation, Armonk, NY (US)

(21) Appl. No.: 13/746,437

(22) Filed: Jan. 22, 2013

(51) Int. Cl. G06F 17/21

(52) U.S. Cl. CPC G06F 17/218
USPC 715/235

(57) ABSTRACT

A mechanism is provided in a data processing system for presenting obfuscated content in a Web document. The mechanism divides source content into a plurality of rectangular portions and re-arranges the rectangular portions to form obfuscated content. The mechanism generates a Web content fragment that defines the plurality of rectangular portions of the obfuscated content as a plurality of group block elements. The mechanism generates style sheet code that defines the positional layout of the plurality of group block elements. The mechanism generates a Web document comprising the Web content fragment and the style sheet code and referencing the obfuscated content.

### BACKGROUND

The present application relates generally to an improved data processing apparatus and method and more specifically to mechanisms for obfuscation of images in Web documents.

Web pages often include intellectual property that the creator or owner wishes to protect. For example, a Web page may present a copyrighted image. The content owner may wish to prevent users from saving and using the image without permission. Another example would involve a content owner hiding images from a search engine or image aggregators by only exposing the obfuscated version to those systems. Current state-of-the-art solutions are easily circumvented through browser-only settings.

One solution includes client-side JavaScript that intercepts mouse events and blocks them. This can be circumvented by loading the page and then disabling JavaScript. Another solution involves covering an image with a transparent overlay image. If the user tries to save the image, the user ends up saving the transparent image instead. However, savvy users can browse the hypertext markup language (HTML) source to locate the full uniform resource locator (URL) and save the image using the URL.

### SUMMARY

In one illustrative embodiment, a method, in a data processing system, is provided for presenting obfuscated content in a Web document. The method comprises dividing source content into a plurality of rectangular portions and re-arranging the rectangular portions to form obfuscated content. The method further comprises generating a Web content fragment that defines the plurality of rectangular portions of the obfuscated content as a plurality of group block elements. The method further comprises generating style sheet code that defines the positional layout of the plurality of group block elements and the portion of the obfuscated content that will be rendered in each block. The method further comprises generating a Web document comprising the Web content fragment and the style sheet code and referencing the obfuscated content.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE SEVERAL VIEWS OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 depicts a pictorial representation of an example distributed data processing system in which aspects of the illustrative embodiments may be implemented;

FIG. 2 is a block diagram of an example data processing system in which aspects of the illustrative embodiments may be implemented;

FIG. 3A depicts an example of a source image to be presented in a Web document in accordance with an illustrative embodiment;

FIG. 3B depicts an example of an obfuscated image in accordance with an illustrative embodiment;

FIG. 4 is a block diagram illustrating a mechanism for obfuscating an image presented in a Web document in accordance with an illustrative embodiment;

FIG. 5 depicts an example of an obfuscated image being unscrambled and presented as the source image in a Web document in accordance with an illustrative embodiment;

FIG. 6 depicts an example of Web content for presenting an obfuscated image in accordance with an illustrative embodiment;

FIG. 7 is a flowchart illustrating operation of a mechanism for obfuscating images in Web content in accordance with an illustrative embodiment; and

FIG. 8 is a flowchart illustrating operation of a browser client presenting an obfuscated image in accordance with an illustrative embodiment.

### DETAILED DESCRIPTION

The illustrative embodiments provide a mechanism for obfuscating images in Web content. The mechanism obfuscates an image to be presented in a Web document by dividing the image into a plurality of rectangular portions and scrambling the plurality of portions into an obfuscated image. The mechanism uses the obfuscated image to re-assemble the source image using cascading style sheets and hypertext markup language code when the Web document is rendered.

In accordance with the illustrative embodiments, the server never sends the source image to the client. Rather, the server sends the obfuscated image, which makes it difficult for the user to obtain the original image. The user is able to view the re-assembled image within the context of the Web document; however, the re-assembled image is not in a form that is able to be saved.

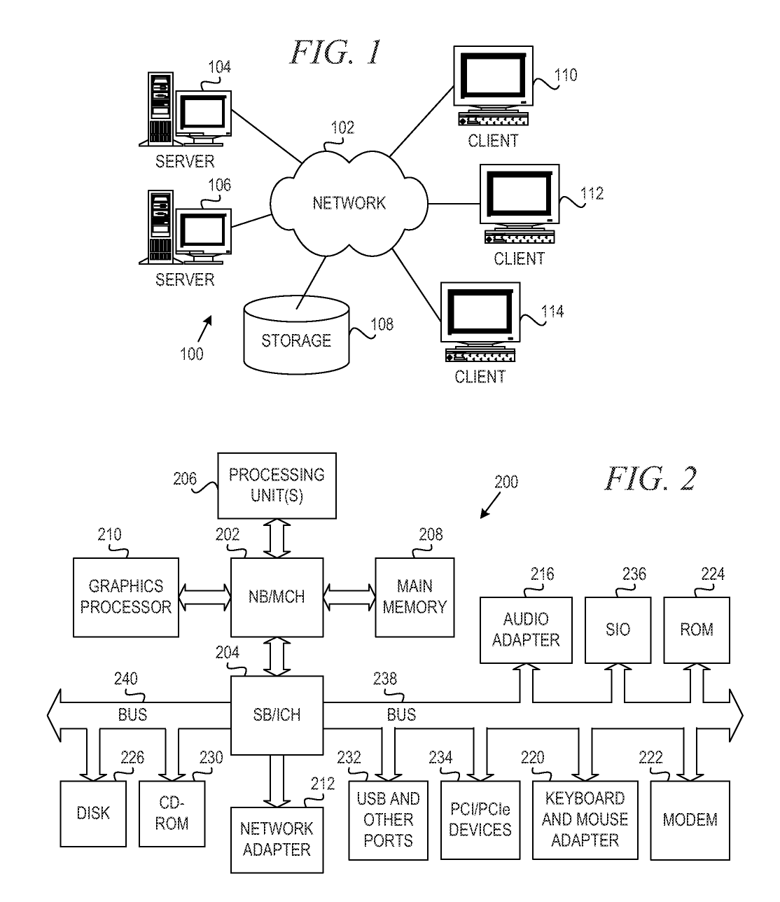

The illustrative embodiments may be utilized in many different types of data processing environments. In order to provide a context for the description of the specific elements and functionality of the illustrative embodiments, FIGS. 1 and 2 are provided hereafter as example environments in which aspects of the illustrative embodiments may be implemented. It should be appreciated that FIGS. 1 and 2 are only examples and are not intended to assert or imply any limitation with regard to the environments in which aspects or embodiments of the present invention may be implemented. Many modifications to the depicted environments may be made without departing from the spirit and scope of the present invention.

FIG. 1 depicts a pictorial representation of an example distributed data processing system in which aspects of the illustrative embodiments may be implemented. Distributed data processing system 100 may include a network of computers in which aspects of the illustrative embodiments may be implemented. The distributed data processing system 100 contains at least one network 102, which is the medium used to provide communication links between various devices and computers connected together within distributed data processing system 100. The network 102 may include connections, such as wire, wireless communication links, or fiber optic cables.

In the depicted example, server 104 and server 106 are connected to network 102 along with storage unit 108. In addition, clients 110, 112, and 114 are also connected to network 102. These clients 110, 112, and 114 may be, for example, personal computers, network computers, or the like. In the depicted example, server 104 provides data, such as boot files, operating system images, and applications to the clients 110, 112, and 114. Clients 110, 112, and 114 are clients to server 104 in the depicted example. Distributed data processing system 100 may include additional servers, clients, and other devices not shown.

In the depicted example, distributed data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, the distributed data processing system 100 may also be implemented to include a number of different types of networks, such as for example, an intranet, a local area network (LAN), a wide area network (WAN), or the like. As stated above, FIG. 1 is intended as an example, not as an architectural limitation for different embodiments of the present invention, and therefore, the particular elements shown in FIG. 1 should not be considered limiting with regard to the environments in which the illustrative embodiments of the present invention may be implemented.

FIG. 2 is a block diagram of an example data processing system in which aspects of the illustrative embodiments may be implemented. Data processing system 200 is an example of a computer, such as client 110 in FIG. 1, in which computer usable code or instructions implementing the processes for illustrative embodiments of the present invention may be located.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 may be connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash basic input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 may be connected to SB/ICH 204.

An operating system runs on processing unit 206. The operating system coordinates and provides control of various components within the data processing system 200 in FIG. 2. As a client, the operating system may be a commercially available operating system such as Microsoft Windows 7 (Microsoft and Windows are trademarks of Microsoft Corporation in the United States, other countries, or both). An object-oriented programming system, such as the Java programming system, may run in conjunction with the operating system and provides calls to the operating system from Java programs or applications executing on data processing system 200 (Java is a trademark of Oracle and/or its affiliates.).

As a server, data processing system 200 may be, for example, an IBM® eServer™ System p® computer system, running the Advanced Interactive Executive (AIX®) operating system or the LINUX operating system (IBM, eServer, System p, and AIX are trademarks of International Business Machines Corporation in the United States, other countries, or both, and LINUX is a registered trademark of Linus Torvalds in the United States, other countries, or both). Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and may be loaded into main memory 208 for execution by processing unit 206. The processes for illustrative embodiments of the present invention may be performed by processing unit 206 using computer usable program code, which may be located in a memory such as, for example, main memory 208, ROM 224, or in one or more peripheral devices 226 and 230, for example.

A bus system, such as bus 238 or bus 240 as shown in FIG. 2, may be comprised of one or more buses. Of course, the bus system may be implemented using any type of communication fabric or architecture that provides for a transfer of data between different components or devices attached to the fabric or architecture. A communication unit, such as modem 222 or network adapter 212 of FIG. 2, may include one or more devices used to transmit and receive data. A memory may be, for example, main memory 208, ROM 224, or a cache such as found in NB/MCH 202 in FIG. 2.

Those of ordinary skill in the art will appreciate that the hardware in FIGS. 1 and 2 may vary depending on the implementation. Other internal hardware or peripheral devices, such as flash memory, equivalent non-volatile memory, or optical disk drives and the like, may be used in addition to or in place of the hardware depicted in FIGS. 1 and 2. Also, the processes of the illustrative embodiments may be applied to a multiprocessor data processing system, other than the SMP system mentioned previously, without departing from the spirit and scope of the present invention.

Moreover, the data processing system 200 may take the form of any of a number of different data processing systems including client computing devices, server computing devices, a tablet computer, laptop computer, telephone or other communication device, a personal digital assistant (PDA), or the like. In some illustrative examples, data processing system 200 may be a portable computing device that is configured with flash memory to provide non-volatile memory for storing operating system files and/or user-generated data, for example. Essentially, data processing system 200 may be any known or later developed data processing system without architectural limitation.

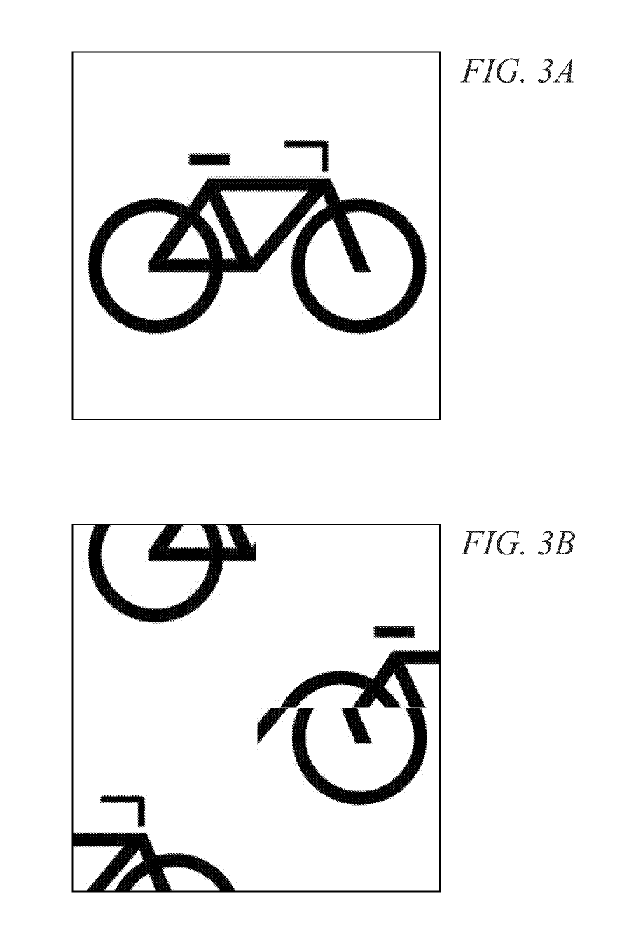

FIG. 3A depicts an example of a source image to be presented in a Web document in accordance with an illustrative embodiment. In accordance with the illustrative embodiment, a mechanism receives a source image and divides the image into a plurality of rectangular portions. The mechanism re-arranges the rectangular portions into a new scrambled image. FIG. 3B depicts an example of an obfuscated image in accordance with an illustrative embodiment. The obfuscated image comprises scrambled rectangular portions of the source image.

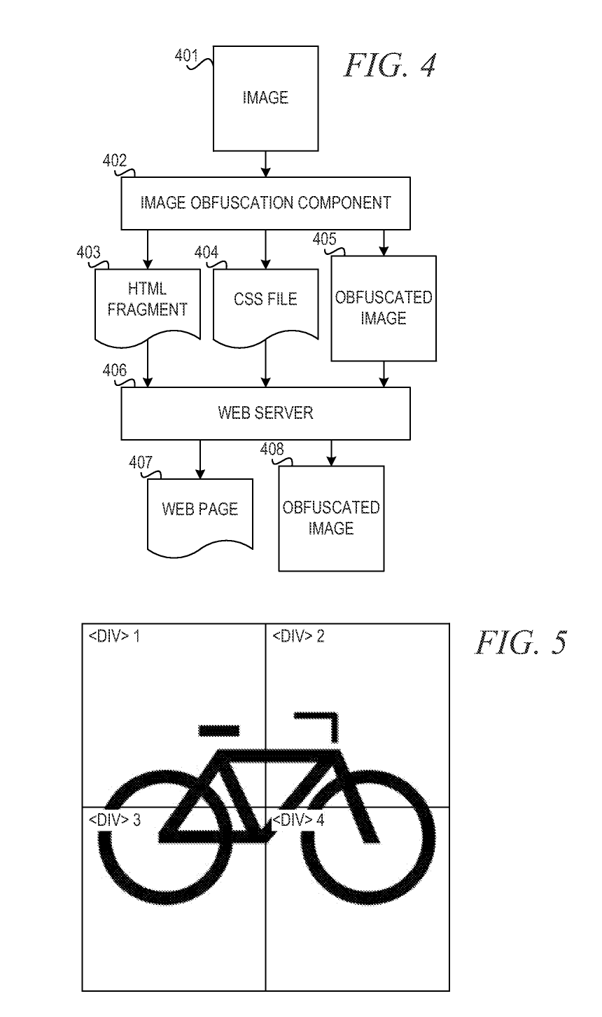

FIG. 4 is a block diagram illustrating a mechanism for obfuscating an image presented in a Web document in accordance with an illustrative embodiment. An image obfuscation component 402 receives a source image 401 that is to be presented within a Web document, such as a hypertext markup language (HTML) document. Image obfuscation component 402 divided the source image 401 into a plurality of rectangular portions, also referred to as “tiles,” and re-assembles the rectangular portions randomly to form a scrambled or obfuscated image 405. The rectangular portions may represent a two-dimensional grid of the source image. Alternatively, the rectangular portions may comprise thin horizontal or vertical stripes of the source image. Other techniques for dividing the source image may become apparent to a person of ordinary skill in the art given the instant disclosure.

The source image may be a copyrighted photograph, design, work of art, graphic, or the like. While the instant disclosure refers to a source image, the source content may be other content that the owner or creator may wish to protect. For example, the source content may be a document, such as a sample page of a book or magazine, a presentation slide, a spreadsheet, a computer drawing file, or the like.

Image obfuscation component 402 generates Web content fragment 403 that presents the image as a plurality of content portions. In the depicted example, Web content fragment 403 may an HTML fragment comprising a plurality of divisions or group block elements of Web content. The group block elements may be delineated using <div> tags. These <div> tags may be used to group block elements to format them with cascading style sheets (CSS). Web content fragment 403 defines the rectangular portions of the obfuscated image as group block elements to make up the image to be presented.

In the depicted example, image obfuscation component 402 also generates a CSS file 404, which defines how group block elements are to be arranged in the Web document. Cascading Style Sheets (CSS) are a style sheet language used for describing the presentation semantics (the look and formatting) of a document written in a markup language. The most common application of CSS is to style web pages written in HTML. CSS is designed primarily to enable the separation of document content (written in HTML or a similar markup language) from document presentation, including elements such as the layout, colors, and fonts. This separation can improve content accessibility, provide more flexibility and control in the specification of presentation characteristics, enable multiple pages to share formatting, and reduce complexity and repetition in the structural content, such as by allowing for Web design without tables. In accordance with the illustrative embodiment, CSS file 404 defines layout of the obfuscated image such that rectangular portions, or tiles, of the obfuscated image are presented at specific positions to effect unscrambling of the image to result in the source image.

Image obfuscation component 402 provides HTML fragment 403, CSS file 404, and obfuscated image 405 to Web server 406, which provides Web page 407 and obfuscated image 408. In one example embodiment, Web server 406 may store Web page 407 and obfuscated image 408 to be retrieved by a client. In an alternative embodiment, image obfuscation component 402 may generate HTML fragment 403, CSS file 404, and obfuscated image 405 dynamically, and Web server 406 may incorporate or reference HTML fragment 403 and CSS file 404 into Web page 407 dynamically in response to a client request.

In one example embodiment, HTML fragment 403 may reference CSS file 404, and Web page 407 may reference HTML fragment 403 and CSS file 404. In another example embodiment, Web server 406 may incorporate HTML fragment 403 and CSS file 404 into Web page 407.

In accordance with the illustrative embodiment, the source image is never provided to the client. The browser at the client uses HTML code from HTML fragment 403 and CSS code from CSS file 404 to unscramble obfuscated image 408 to effect presentation of the source image.

FIG. 5 depicts an example of an obfuscated image being unscrambled and presented as the source image in a Web document in accordance with an illustrative embodiment. The HTML fragment defines the group block elements. The CSS file defines the layout of how the group block elements will be presented. The browser uses the HTML fragment and the CSS file to re-arrange the tiles of the obfuscated image to result in the source image.

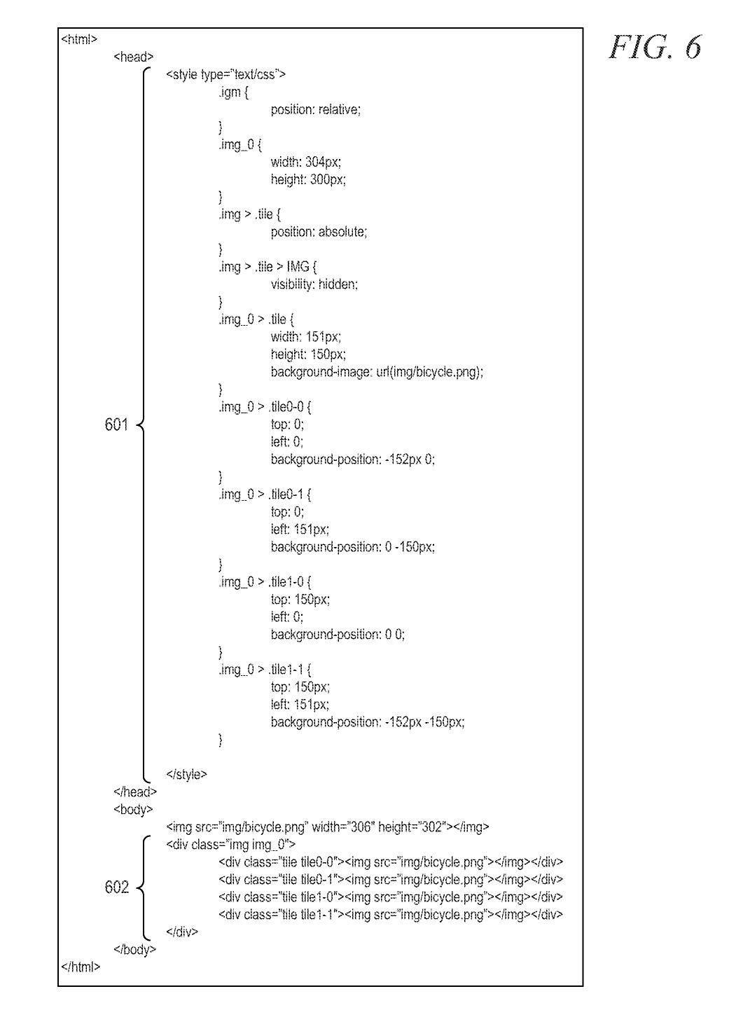

FIG. 6 depicts an example of Web content for presenting an obfuscated image in accordance with an illustrative embodiment. The Web content comprises Web content fragment 602, which defines group block elements to make up the image to be presented and references the obfuscated image. The Web content also comprises style sheet code 601, which defines how the group block elements are to be arranged in the Web document. As shown in FIG. 6, the CSS code defines a size of the image and a size of each tile. For each tile, the CSS code 601 defines a position at which the tile is to be presented and a position within the obfuscated image of the tile. The Web content fragment 602 refers to CSS code 601 for each group block element to establish how the group block element, or tile, is to be presented.

As will be appreciated by one skilled in the art, the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in any one or more computer readable medium(s) having computer usable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in a baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Computer code embodied on a computer readable medium may be transmitted using any appropriate medium, including but not limited to wireless, wireline, optical fiber cable, radio frequency (RF), etc., or any suitable combination thereof.

Computer program code for carrying out operations for aspects of the present invention may be written in any combination of one or more programming languages, including an object oriented programming language such as Java™, Smalltalk™, C++, or the like, and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to the illustrative embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions that implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus, or other devices to produce a computer implemented process such that the instructions which execute on the computer or other programmable apparatus provide processes for implementing the functions/acts specified in the flowchart and/or block diagram block or blocks.

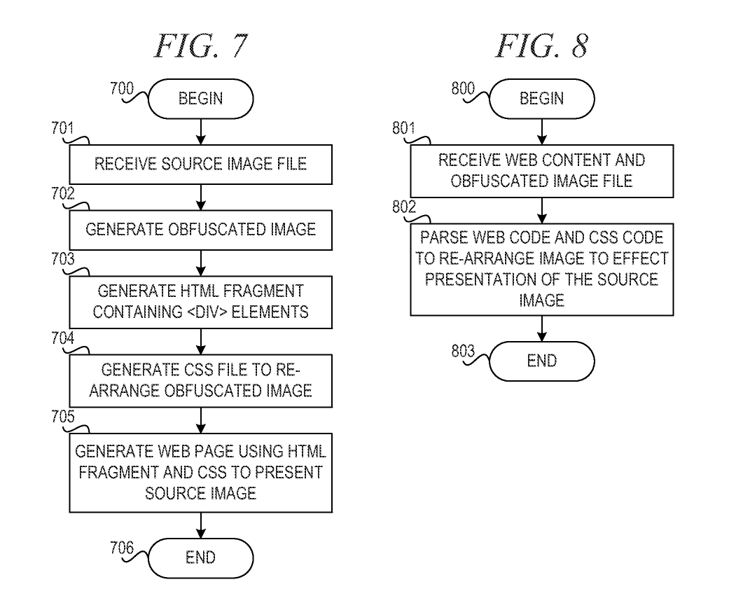

FIG. 7 is a flowchart illustrating operation of a mechanism for obfuscating images in Web content in accordance with an illustrative embodiment. Operation begins (block 700), and the mechanism receives the source image file (block 701). The mechanism divides the source image file into rectangular portions and re-arranges the rectangular portions to generate an obfuscated image (block 702).

The mechanism then generates a Web content fragment that defines group block elements of the image to be presented (block 703). The Web content fragment may comprise hypertext markup language (HTML) having <div> tags to define the group block elements.

The mechanism generates a style sheet file containing code that re-arranges the obfuscated image (block 704). The style sheet code may comprise cascading style sheet (CSS) code that defines the positional layout of the tiles such that the tiles of the obfuscated image are presented at specific positions to effect unscrambling of the image to result in the source image.

The mechanism then generates a Web page using the Web content fragment and the style sheet code to present the source image (block 705). The Web page comprises the Web content fragment and the style sheet code. The mechanism may generate the Web page dynamically in response to a request from a client such that a different obfuscated image is generated for each request. Alternatively, the mechanism may generate the Web page and store the obfuscated image and Web page for later retrieval for an improved response time. Thereafter, operation ends (block 706).

FIG. 8 is a flowchart illustrating operation of a browser client presenting an obfuscated image in accordance with an illustrative embodiment. Operation begins (block 800), and the browser client receives Web content and a referenced obfuscated image (block 801). The Web content comprises the Web content fragment, which defines group block elements of the image to be presented, and the style sheet code, which defines the positional layout of the tiles such that the tiles of the obfuscated image are presented at specific positions to effect unscrambling of the image to result in the source image. The browser client parses the Web code fragment and the style sheet code to re-arrange the obfuscated image to effect presentation of the source image (block 802). Thereafter, operation ends (block 803).

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Thus, the illustrative embodiments provide mechanisms for presenting obfuscated images in Web content. A mechanism in a Web server divides a source image into rectangular portions and re-assembles the rectangular portions to form an obfuscated image. The mechanism then generates a Web content fragment that defines portions of the obfuscated image as group block elements to be presented. The mechanism also generates style sheet code that defines the positional layout of the group block elements to re-arrange the rectangular portions such that the rectangular portions are re-arranged to present the source image. The Web server provides a Web document that references the obfuscated image and comprises the Web content fragment and the style sheet code. A browser client may then parse the Web content fragment and style sheet code to re-arrange the obfuscated image to effect presentation of the source image. The browser client never receives the source image.

As noted above, it should be appreciated that the illustrative embodiments may take the form of an entirely hardware embodiment, an entirely software embodiment or an embodiment containing both hardware and software elements. In one example embodiment, the mechanisms of the illustrative embodiments are implemented in software or program code, which includes but is not limited to firmware, resident software, microcode, etc.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method, in a data processing system, for presenting obfuscated content in a Web document, the method comprising:
dividing source content into a plurality of rectangular portions;
re-arranging the rectangular portions to form obfuscated content;
generating a Web content fragment that defines the plurality of rectangular portions of the obfuscated content as a plurality of group block elements;
generating style sheet code that defines the positional layout of the plurality of group block elements; and
generating a Web document comprising the Web content fragment and the style sheet code and referencing the obfuscated content.

2. The method of claim 1, further comprising:
responsive to a request from a client, providing the Web document and the obfuscated content to the client.

3. The method of claim 2, wherein a browser at the client receives the Web document and the obfuscated content, parses the Web content fragment and the style sheet code, and re-arranges the rectangular portions of the obfuscated content based on the Web content fragment and the style sheet code to effect presentation of the source content.

4. The method of claim 1, wherein the source content is an image file.

5. The method of claim 1, wherein the Web content fragment comprises hypertext markup language code.

6. The method of claim 5, wherein the hypertext markup language code comprises <div> tags that define the plurality of group block elements.

7. The method of claim 1, wherein the style sheet code comprises a cascading style sheet.

8. The method of claim 7, wherein the Web content fragment comprises hypertext markup language code that references the cascading style sheet for each given group block element to establish a position at which the given group block element is to be presented and a portion of the obfuscated content that will be rendered in each group block element.

9. The method of claim 1, wherein a Web server performs dividing the source content into the plurality of rectangular portions, re-arranging the rectangular portions to form the obfuscated content, generating the Web content fragment, and generating the style sheet code dynamically in response to receiving a request from a client.

10. The method of claim 1, wherein a Web server performs generating the Web document dynamically in response to receiving a request from a client.

11. A computer program product comprising a computer readable storage medium having a computer readable program stored therein, wherein the computer readable program, when executed on a computing device, causes the computing device to:
divide source content into a plurality of rectangular portions;
re-arrange the rectangular portions to form obfuscated content;
generate a Web content fragment that defines the plurality of rectangular portions of the obfuscated content as a plurality of group block elements;
generate style sheet code that defines the positional layout of the plurality of group block elements; and
generate a Web document comprising the Web content fragment and the style sheet code and referencing the obfuscated content.

12. The computer program product of claim 11, wherein the computer readable program further causes the computing device to:
responsive to a request from a client, provide the Web document and the obfuscated content to the client.

13. The computer program product of claim 11, wherein the source content is an image file.

14. The computer program product of claim 11, wherein the style sheet code comprises a cascading style sheet.

15. The computer program product of claim 11, wherein the computer readable program is stored in a computer readable storage medium in a data processing system and wherein the computer readable program was downloaded over a network from a remote data processing system.

16. The computer program product of claim 11, wherein the computer readable program is stored in a computer readable storage medium in a server data processing system and wherein the computer readable program is downloaded over a network to a remote data processing system for use in a computer readable storage medium with the remote system.

17. An apparatus, comprising:
a processor; and
a memory coupled to the processor, wherein the memory comprises instructions which, when executed by the processor, cause the processor to:
divide source content into a plurality of rectangular portions;
re-arrange the rectangular portions to form obfuscated content;
generate a Web content fragment that defines the plurality of rectangular portions of the obfuscated content as a plurality of group block elements;
generate style sheet code that defines the positional layout of the plurality of group block elements; and
generate a Web document comprising the Web content fragment and the style sheet code and referencing the obfuscated content.

18. The apparatus of claim 17, wherein the instructions further cause the processor to:
responsive to a request from a client, provide the Web document and the obfuscated content to the client.

19. The apparatus of claim 17, wherein the source content is an image file.

20. The apparatus of claim 17, wherein the style sheet code comprises a cascading style sheet.
